(19) United States
(12) Patent Application Publication
(10) Pub. No.: US 2005/0002493 A1
(43) Pub. Date: Jan. 6, 2005

(54) Anti-scatter device for X-ray imaging

(76) Inventor: Reuven Levinson, Haifa (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/857,230

(22) Filed: Jun. 1, 2004

Related U.S. Application Data
(60) Provisional application No. 60/474,610, filed on Jun. 2, 2003.

(51) Int. Cl. G21K 5/10; G21K 1/00

(52) U.S. Cl. 378/155

(57) ABSTRACT

The present invention provides a novel anti-scatter device for X-ray imaging with a position encoder-controlled grid motion. Te device comprising an X-ray radiation source, which produces a primary beam that is directed to an examined body; a high voltage generator in communication with said X-ray radiation source; an X-ray detector; a grid positioned within said primary beam between said examined body and said X-ray detector; an actuating means adapted to move said grid; a measuring means; adapted to measure the position of the grid during the X-ray exposure; and a controlling means for synchronizing the grid motion with the X-ray exposure.

### CROSS-REFERENCE TO RELATED APPLICATIONS

This application claims priority from U.S. Patent Application No. 60/474,610, filed Jun. 2, 2003, which is hereby incorporated in its entirety.

### FIELD OF THE INVENTION

The present invention generally relates to an anti-scatter device for X-ray imaging and a method thereof.

### BACKGROUND OF THE INVENTION

The Potter-Bucky grid was invented approximately a hundred years ago and is still the most effective device for reducing scattered radiation in projection X-ray imaging. It is usually manufactured in the form of a thin plate in which very thin strips (septa) of radiopaque material, commonly lead, are placed in a linear parallel pattern. The spaces between the lead strips are filled with radiolucent material, typically aluminum.

A moving grid was invented in the 1920s. The motion mechanism is usually called a bucky. The grid is set into motion i.e., oscillating back and forth, before starting the X-ray exposure. This motion blurs the shadows of the grid's lead strips in the X-ray image.

The efficiency of the grid action is measured by the selectivity parameter (Σ), which is the ratio of the grid's primary transmission (Tₚ) to the grid's scatter transmission (Tₛ). For current commercially available grids, primary transmission values are typically from 0.6 to 0.75, and selectivity values typically range from 3 to 10.

The quantity of scattered radiation in an imaging procedure is measured by the scatter-to-primary ratio (SPR), which is the ratio of scattered radiation to primary radiation incident on the X-ray detector. This parameter has been measured by a number of researchers and reported values range from 1 to 10 for X-ray imaging procedures with typical technique factors and body parts of thickness up to 20 cm.

The deleterious effects of scattered radiation on image quality have been well documented: scattered radiation, absorbed by the X-ray detector, reduces the signal-to-noise ratio of the image according to the formula:
SNRₒ=SNRᵢ{Tₚ(1+SPR/Σ)⁻¹}
wherein SNRᵢ is the signal-to-noise ratio without scattered radiation, and SNRₒ is the signal-to-noise ratio with scattered radiation.

For X-ray imaging examinations with current technology grids the resultant SNR is reduced because of the limitations in the grid selectivity. For thick body parts, in excess of 20 cm, improved grid performance can improve the signal-to-noise ratio of the X-ray images by a factor of more than 2. Therefore, there is a need for grids with improved performance, i.e., larger primary transmission and smaller scatter transmission.

High performance grids can be achieved with large septa. These grids, however, produce severe grid-line artifacts. In order to eliminate the appearance of these grid-line artifacts, the grid motion must be precisely controlled and synchronized with the X-ray source output.

Several patents focused on improving the oscillating grid, such as U.S. Pat. No. 5,305,369 to Johnson that presents a grid for use with an X-ray system comprising a grid; a mechanical drive to reciprocate said grid; and an integrated circuit chip control for said motor, wherein the grid is adapted to operate in a semi-automatic mode in which an operator activates said motor, and the grid is alternatively operated in an automatic mode in which a signal from an X-ray generator utilized with said bucky activates said motor. Similarely, U.S. Pat. No. 4,646,340 to Bauer that presents a scatter grid drive for oscillating a scatter grid back and forth during an exposure. The reversal point, at which the direction of grid movement is reversed, is passed so quickly that there is little risk of imaging the grid in the radiograph. U.S. Pat. No. 6,181,773 to Lee discloses a radiation anti-scatter device comprising a grid, a grid path comprising a start grid position at the first end of said path and a finish grid position at the second end of said path; and a grid driver connected to said grid for moving said grid during an operating cycle from said start position to said finish grid position in a single unidirectional stroke at a variable speed along said path.

Limited synchronization between the X-ray output and the grid motion is provided in commercially available systems: Before the start of the X-ray exposure the high voltage generator sends a ‘start’ signal to the bucky. When the bucky reaches the required velocity, it returns a ‘ready’ signal to the high voltage generator; and after the end of the X-ray exposure: the high voltage generator sends an ‘end’ signal to the bucky.

Without any exact synchronization, the current bucky systems utilize the speed of the bucky to reduce the intensity of the grid-line artifacts. It is reported in the literature that grid displacement in excess of the 20 grid cycles during the X-ray exposure reduces the intensity of the grid-line artifact to below visible levels. While this method is successful for grid with thin septa (about 0.05 mm), it is practically unachievable for grids with larger septa

A synchronized anti-scatter device for projection X-ray imaging is thus still a long felt need.

### SUMMARY OF THE INVENTION

It is thus an object of the present invention to present an anti-scatter device for X-ray imaging with a position encoder-controlled grid motion. This device comprises inter alia the following nine components: (i) an X-ray radiation source, which produces a primary X-ray beam that is directed to an examined body; (ii) a high voltage generator in communication with said X-ray radiation source; (iii) an X-ray detector; (iv) a grid positioned within said primary beam between said examined body and said X-ray detector; (v) an actuating means adapted to move said grid in a plane perpendicular to the central axis of said primary X-ray beam; (vi) a measuring means adapted to measure the intensity of said primary beam at every moment during the X-ray exposure; (vii) a measuring means to measure the position of said grid at every moment during the X-ray exposure; (viii) a measuring means to measure the intensity of X-ray radiation incident on said X-ray detector, and (ix) a controlling means, in communication with said measuring means of the incident radiation on the X-ray detector, in communication with said actuating and measuring means of the grid position and also in communication with said high voltage generator, for synchronizing the grid motion with the X-ray exposure.

It is in the scope of the present invention wherein the exposure time is known before the start of the exposure and the exposure time is transmitted to the control means, the control means calculates the grid velocity as a function of the exposure time, the primary beam intensity is a constant function, the grid velocity is constant during the X-ray exposure, the grid displacement is equal to an integral number of the grid cell lengths and the displacement path is symmetric about the center position.

It is in the scope of the present invention wherein the exposure time is known before the start of the exposure and the exposure time is transmitted to the control means, the primary beam intensity is a pseudo-constant function, the grid velocity is constant during the X-ray exposure, the grid displacement is equal to a distance that produces an equal effective primary beam fluence for all the detector points and the displacement path is symmetric about the center position.

The device may alternatively be adapted for an AEC operation mode with a constant X-ray output source, wherein the exposure time is not known before the start of the exposure. The required exposure time, as determined by the AEC, is adjusted by the control means so that the grid displacement during the X-ray exposure is equal to an integral number of grid cell lengths, and the displacement path of the center of the grid is nearly symmetric about the centrer position. Thus the device may be characteized by control means adapted to recieve a signal from the AEC when a known percentage of the required exposure time has been obtained. The control means are adapted to calculate the closest integral multiple of the grid cell time to the required exposure time and to send a termination signal to the high voltage generator at the calculated time.

The device may alternatively be adapted for an AEC operation mode with a pseudo constant X-ray output source, wherein the exposure time is not known before the start of the exposure. The required exposure time, as determined by the AEC, is adjusted by the control means so that the grid displacement during the X-ray exposure is equal to a distance that produces an equal effective primary beam fluence for all the detector points and the displacement path is nearly symmetric about the center position. The device may be characteized by control means that are adapted to recieve a signal from the AEC when a known percentage of the required exposure time has been obtained.

The control means are adapted to calculate the distance that produces an equal effective primary beam fluence for all the detector points and the displacement path is nearly symmetric about the center position and to send a termination signal to the high voltage generator at the calculated time.

It is acknowledged in this respect that the grid may be characterized by a repeating pattern of radiopaque septa and radiolucent interspace material; and/or that the grid motion may be selected in a non limiting manner from any linear, oscillatory, rotary, circular motion, maneuver, actuation or tilting operation or any combination thereof.

It is also in the scope of the present invention wherein the grid motion is in a plane perpendicular to the central axis of the X-ray primary beam in such a manner that after a given grid cell time all the septa have moved to a location such that the location of the complete septa pattern in the area between the examined body and the detector is the same.

The septa according to the present invention may be selected from septa parallel to each other; so-called parallel grid, or septa that are angulated with respect to each other; so-called focused grid. The angle of the septa is such that the plane of the septa is co-planar with a ray of the primary beam when the grid is in its center position.

It is also in the scope of the present invention wherein the aforesaid actuating means of the grid has a position encoder that measures the position of the grid during the X-ray exposure. Said position encoder may inter alia be comprised of a time clock, which provides measurement of the position of the grid as a function of time.

The position of the grid, with respect to the X-ray detector, can at determined for a reference location of the grid. Therefore, the measure of the grid position as offset from the reference location provides a measure of the grid location with respect to the X-ray detector for any grid position offset from the reference location. The grid transmission is a known function of the grid position. Therefore, measure of the grid position as a function of time also provides a direct measure of the grid transmission for each detector point as a function of time.

The device may be alternatively be adapted for an AEC operation mode with a digital X-ray detector and with a non-constant X-ray output source. The measure of the primary beam intensity, and the grid transmission are input to the calculation means which calculates the effective primary beam fluence. The measured detector pixel values are divided by the effective primary beam fluence. The division procedure normalizes the detector pixel values so that the need for a constant or pseudo-constant X-ray output source is eliminated.

Said device may be further comprised of a rotary actuating means. The axis of rotation of the grid is at the center of the grid and is coincidental with the central axis of the primary beam; therefore the grid is always in the center position. The rotational motion provides endless motion and replaces the need for exact synchronization of the actuator means with the high voltage generator with a simpler requirement: the grid motion begins before the start of the X-ray exposure and terminates after the end of the X-ray exposure. No restriction is placed on the starting position of the grid or the length of the displacement path. The combination of the X-ray source shape (point source) and the rotational grid motion eliminates ant de-centering action of the grid motion.

### BRIEF DESCRIPTION OF THE INVENTION

In order to understand the invention and to see how it may be implemented in practice, a preferred embodiment will now be described, by way of non-limiting example only, with reference to the accompanying drawings, in which

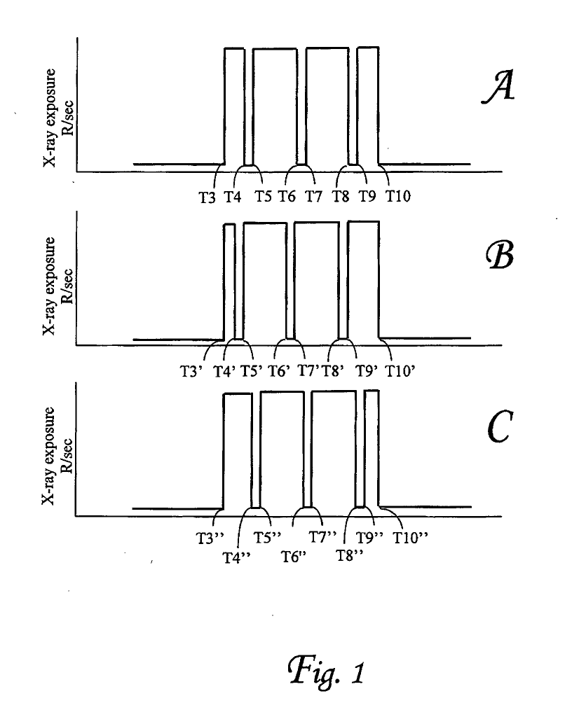

FIG. 1 schematically presents the primary beam intensity from constant X-ray source and grid, three points on the X-ray detector, wherein graph A presents point P, graph B presents point P′ and graph C presents point P″;

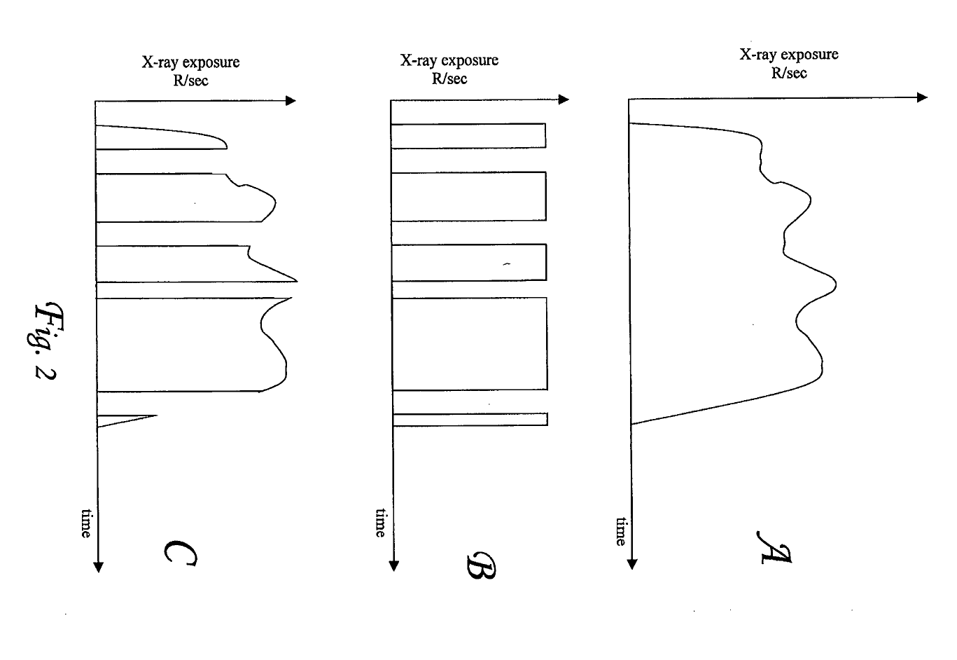

FIG. 2A schematically presents the primary beam intensity from a non-constant X-ray source. The grid transmission at arbitrary point P is presented in FIG. 2B. The effective primary beam intensity at arbitrary point P is presented in FIG. 2C

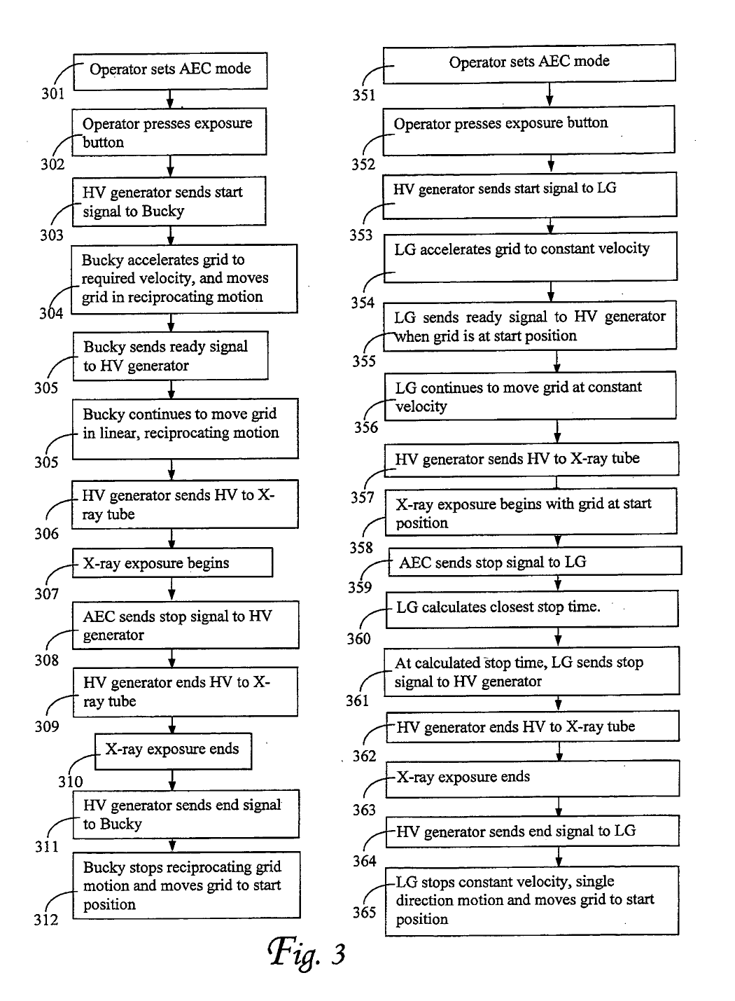

FIG. 3 schematically presents a method for removing scattered radiation by means of a novel Levinson grid as defined in the present invention in an AEC mode; and,

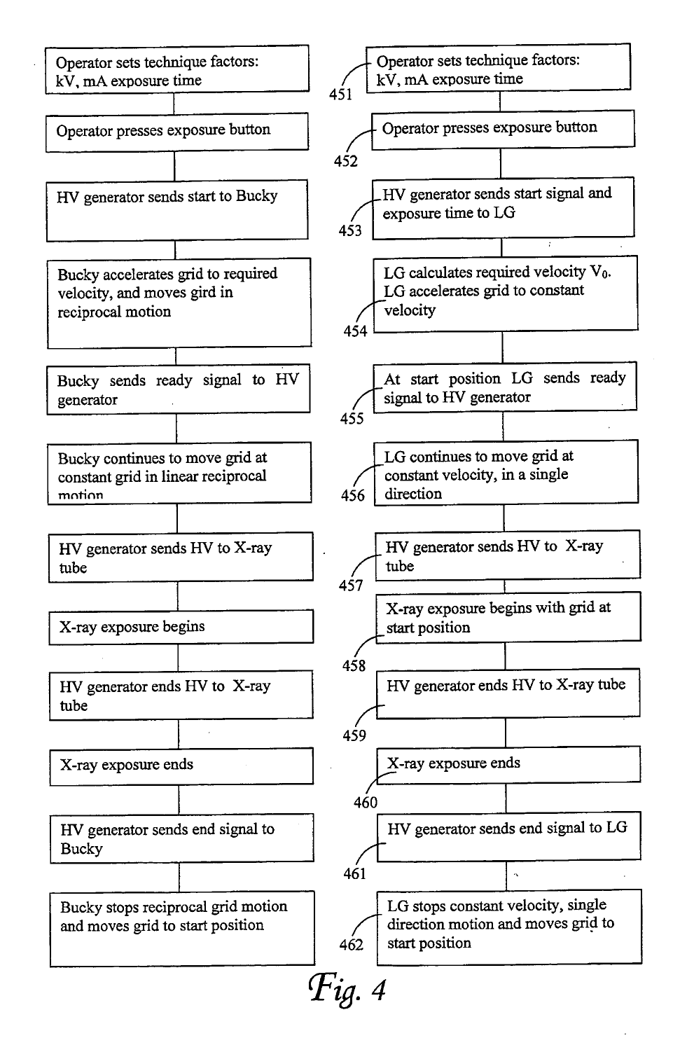

FIG. 4 schematically presents a method for removing scattered radiation by a means of a novel Levinson grid in a fixed mAs mode.

### DETAILED DESCRIPTION OF THE INVENTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide an anti-scatter device for X-ray imaging with a position encoder-controlled grid motion and a method for removing scattered radiation generated in the examined body (hereinafter ‘Levinson grid’, LG).

The term ‘X-ray source output’ refers hereinafter to a primary beam intensity (photons/mm²/sec), i.e., the number of photons emitted by the X-ray source in a particular direction per unit area per unit time.

The term ‘Grid cell’ refers hereinafter to a combination of radiopaqe elements (septa) and radioluent elements (inter-space material) that repeats itself over the entire area of the grid.

The term ‘Grid cell length’ refers hereinafter to the length (mm or radians) of a grid cell in the direction of the grid motion.

The term ‘Grid cell time’ refers hereinafter to the time (see) for the grid to move one grid cell length.

The term ‘center position’ refers hereinafter to the position in which the geometric center of the grid is aligned with the central axis of the primary beam.

The term ‘displacment path’ refers to the locus of points on the grid that pass between the center of the X-ray detector and the X-ray radiation source.

The term ‘displacement path length’ refers to the length of the displacement path.

The term ‘Automatic Exposure Control’ (AEC) refers hereinafter to a module which measures the photon fluence incident on the X-ray detector and outputs an electrical signal proportional to the measured photon fluence. The term ‘AEC mode’ refers to a mode in which the exposure time is set by the AEC.

The term ‘required exposure time’ refers to exposure time are set by the AEC.

The term ‘Fixed mAs mode’ (mAs) refers hereinafter to the operating mode wherein the technique factors, X-ray tube current (milliampere) and exposure time (seconds) are set by the X-ray technologist before the start of the X-ray examination.

The term ‘Pseudo-constant’ refers hereinafter to an X-ray exposure with an intensity profile of three parts: 1^{st} part: rise time: the X-ray source output increases from 0 to a constant value; 2^{nd} part: constant time: the X-ray source output is constant; and 3^{rd} part: fall time: the X-ray source output decreases from a constant value to 0.

The term ‘radiopaque grid member’ refers hereinafter to an X-ray anti-scatter member that when introduced between the patient and the X-ray detector, reduces the amount of scattered radiation that can reach the detector. The area of the grid is equal to or larger than the detector area. The grid is composed of a repeating pattern of grid cells. Each grid cell is composed of a combination of radiopaque septa and radiolucent interspace material.

The term ‘bucky’ refers hereinafter to the motion mechanism of the radiopaque grid member, which is set into linear or rotational motion, single directional or oscillating, before an X-ray exposure starts. The purpose is to reduce the shadows produced by the grid septa. The grid motion is selected in a non-limiting manner from, e.g., linear; rotary; single stroke; oscillating motion; circular or any combination thereof. This motion is in a plane perpendicular to the central axis of the X-ray beam, and the grid moves in such a manner that after a given time, TGC, i.e., grid cell time, the grid has moved a grid cell length and all the grid septa have moved to the location of an adjacent cell; and the location of the complete septa pattern in the area between the patient and the detector is the same.

The term “grid transmission (GT(x, y, t))” refers hereinafter to the percent of the primary beam fluence transmitted by the grid for a detector point (x, y).

The term “effective primary beam fluence (PBF) of each detector point” refers hereinafter to the primary beam fluence, during the exposure time, minus the primary beam fluence absorbed by the grid during the exposure time, or in other words, the primary beam fluence that is transmitted through the grid and is incident on the X-ray detector during the exposure time: effective PBF=∫PBF(x, y, t) GT(x, y, t) dt.

It is acknowledged that for a constant and pseudo-constant primary beam intensity the grid velocity is constant. Alternatively, for digital detectors the primary beam intensity and the grid transmission can be measured at every moment during the X-ray exposure, for each pixel of the detector. The measured detector pixel values are normalized with the effective primary beam fluence. This normalization procedure eliminates the appearance of septa in the X-ray image.

For fixed milliamp per second (mAs) mode of operation, the exposure time is known before the start of the exposure. For a constant primary beam intensity the magnitude of the grid velocity, V_{g}, is adjusted to the X-ray exposure time, T, in such a manner that that the grid moves an integral number, N, of grid cycle lengths, L_{GC}, during the X-ray exposure time:
V_{g}*T=N*L_{GC}
V_{g}=N·L_{GC}/T

The displacement path in linear moving grids is symmetric about the center position and in rotating grids is constant on the central axis of the beam. The selection of N influences the magnitude of the grid velocity, the magnitude of the grid cutoff effect (for linear motion), and the length of the displacement path (for linear motion). For N=1, the magnitude of all three parameters is minimized; however the magnitude of the grid line artifact, for a given error in the displacement, is maximized.

It is according to one embodiment of the present invention wherein the control means receives a ‘ready’ signal, e.g., a signal is provided from the high voltage (HV) generator, the control means starts the grid motion and when the grid motion reaches a constant velocity, the control means sends a ready signal to the HV. The HV generator starts the X-ray exposure for a constant X-ray output. The grid velocity remains constant during the X-ray exposure. Said grid velocity is adapted to move the grid in an integral number of grid cell cycles, symmetrically about the center position, during the course of the X-ray exposure.

For example, for T=300 ms, and L_{GC}=3 mm; and a 30 mm grid displacement, N=10 and V_{g}=(30 mm)/(0.3 sec)=100 mm/sec.

The bucky has a limited range of displacements: from one grid cycle to the maximum grid displacement allowed by the Bucky. In order to limit the grid cutoff and to maintain compatibility with current, commercially available Bucky systems, the maximum displacement is in the range of 25 mm. For example, for a grid cell length of 2 mm, this corresponds to a maximum N=12.

Therefore, the range of “required exposure time” enabled by the LG is limited to the travel times of the grid from one to twelve grid cycles. For a constant grid velocity, this corresponds to a range of 12 in X-ray exposure time.

In addition, because of the unknown displacement length of the grid, the displacement path cannot be made symmetric to the center position. In order to prevent “out-of-limit” operation the start position of the grid is set at 12 mm from the center position.

For AEC operation mode with constant primary beam intensity, the exposure time is not known before the start of the exposure. Therefore, the grid velocity cannot be set according to the exposure time. The controls means must receive an estimate exposure time: this value may be derived from the inverse of the tube current. The grid velocity is set so that the estimated exposure time will result in a displacement path equal to one-half the maximum displacement enabled by the Bucky. According to the above example for N=12, a grid cell length of 2 mm and an estimated exposure time of 0.1 seconds, the grid velocity is 120 mm/sec and the range of exposure time is from 0.03 seconds to 0.36 seconds. In this case, the “required exposure time”, as determined by the AEC is slightly adjusted by the actuating means so that the grid displacement during the X-ray exposure is equal to an integral number of grid cycle lengths. With the above example, if the “required exposure time” determined by the AEC is 0.155 seconds, then the control means will adjust it to 0.150 seconds (5 grid cell lengths).

The control means receives a signal from the AEC when a known percentage of the “required exposure time” has been reached. The control means calculates the integral multiple of the grid cell time, N*T_{GC}, closest to the “required exposure time”. The control means sends a termination signal to the high voltage generator at time, N* T_{GC}. The X-ray exposure is ended N*T_{GC} seconds after the start of the radiation. The grid motion is terminated after the end of the X-ray exposure.

Current technology grids for use with X-ray energies in the range of 40-120 kV utilize linear lead septa of thickness in the range of 0.05 mm and 2 mm in height, aluminum or carbon fiber interspace material with widths in the range of 0.2 mm, grid ratio in the range of 12, and grid lead weights of 0.4 g/cm².

The present invention utilizes a large, non-linear septa structure: zig-zag, square or hexagonal shape, thickness in the range of 0.2 mm, height in the range of 20 mm, air inter-space material, distance between septa in the range of 2 mm, grid ratio in the range of 12 and grid lead weight in the range of 2 g/cm².

The dimensions and shape of the present invention reduce the scatter transmission by a factor of 5 to 80 and increase the primary transmission by a factor of 1.2. Selectivity is increased by a factor or 6 to 100.

Current commercial grids are available in parallel or focused configurations. The same is true of the Levinson grid.

The rotational motion of the current invention can utilize a spiral or interleaved spiral shaped septa of the shape:
r_{b}(θ)=(a*θ)+(b*φ); b=1, 2, . . . N
wherein φ360/N; N=1, 2, 3, . . . such that 360/N is an integer less than or equal to 360°.

In order to decrease the acceptance angle of the spiral or interleaved spiral grid, an identical spiral or interleaved spiral grid in the reverse direction can be added on top of the first grid:
r_{b}(θ)=(a*−θ)+(b*−φ); b=1, 2, . . . N
wherein φ=360/N; N=1, 2, 3, . . . such that 360/N is an integer less than or equal to 360®.

It is according to yet another embodiment of the present invention whereby a useful method for removing scattered X-ray by a means of a novel LG is provided, wherein the operator sets an AEC mode and presses the exposure button. The high voltage generator is hence directed to send a ‘start’ signal to said LG, so that it accelerates to a constant and predetermined velocity along a single direction. When the LG reaches the predetermined velocity it sends a ‘ready’ signal to the HV generator, and continues to move at said constant velocity and in said direction. Subsequently, the HV generator sends electrical power in sufficient measure to an X-ray tube. X-ray exposure thus begins. When the AEC has received a predetermined level of radiation, it sends a ‘stop’ signal to the LG. The LG has a processor adapted to calculate the closest stop time and means to sends said stop signal to the HV generator. As a result, the HIV generator ends HV supply to said X-ray tube so that the exposure ends. The HV generator now sends an ‘end’ signal to the LG, which stops said constant-velo city and single-direction motion and moves the grid to a start position.

Reference is made now to FIG. 1, schematically presenting the exposure from a constant X-ray source and grid, three points on the X-ray detector, wherein FIG. 1A presents point P, FIG. 1B presents point P′ and FIG. 1C presents point P″. The grid septa passes over P, P′ and P″ respectively in the order of T3<T3′<T3″; T4<T4′,T4 etc. Each detector point is covered three times by three adjacent septa. The effective primary beam fluence to each point is as follows:
Effective PBF(P)=[PB intensity]×[(T10−T3)−(T9−T8)−(T7−T6)−(T5−T4)];
Effective PBF(P″)=[PB intensity]×[(T10″−T3′)−(T9′−T8′)−(T7″−T6′)−(T5′−T4″)];
Effective PBF(PB″)=[PB intensity]×[(T10″−T3″)−(T9″−T8″)−(T7″−T6″)−(T5″−T4″)];
Effective PBF(P)=Effective PBF(P′)=Effective PBF (P″)

It is according to yet another embodiment of the present invention wherein the aforesaid actuating means of the grid has a position encoder. Said encoder may inter alia be comprised of a time clock, which measures the position of the grid as a function of time, and the position of the grid, with respect to the X-ray detector at a reference time is known, so that the calculation of the exact position of the grid with respect to the X-ray detector pixels is known and the grid transmission is known for each detector point as a function of time.

It is according to yet another embodiment of the present invention wherein a reference detector, comprising inter alia a time clock, measures the X-ray source output as a function of time. The pixel values are thus normalized either in a real time procedure or in a delay function, according to the effective primary beam fluence. This eliminates the need for a constant or pseudo constant X-ray source output.

Reference is made now to FIG. 2A, schematically presenting a non-constant X-ray source output. The grid transmission at arbitrary point P is presented in FIG. 2B. The effective primary beam intensity at arbitrary point P is presented in FIG. 2C.

Table 1 and Table 2 summarize the differences between the state of the art and the novel LG as disclosed in the present inventions in a fixed mAs mode and an AEC mode, respectively.

TABLE 1
Anti-scattering of X-rays by a fixed mAs mode and the
Levinson grid as disclosed in the present invention

| | | Current technology | Levinson grid |
|---|---|---|---|
| Ti | Operator press | | HV sends exposure time to LG. |
| | exposure button. | | |
| | | HV generator sends start | Same |
| | | signal to Bucky. | |
| | | | LG calculates grid velocity |
| | | | according to exposure time |
| | | Bucky accelerates grid to | LG accelerates grid to |
| | | pre-set velocity | calculated velocity |
| T2 | Grid reaches | Grid sends ready signal to | Same |
| | required | HV. | |
| | velocity | | |
| T3 | HV receives | Delay time (T3-T2): | Delay time (T3-T2) must be |
| | ready signal and | receipt of ready signal to | known, so that the grid will be |
| | begins X-ray | start of X-ray exposure is | at the start position with the |
| | exposure | not important. | start of the X-ray (T3). |
| T3- | X-ray exposure | Grid moves in | LG moves in a single direction |
| T10 | | reciprocating linear | to a predetermined |
| | | motion | displacement. |
| T11 | End of X-ray | HV sends end signal to | Same |
| | exposure | grid. | |

TABLE 2
Anti-scattering of X-rays by an AEC mode and the Levinson grid as
disclosed in the present invention:

| | | Current technology | Levinson grid |
|---|---|---|---|
| T1 | Operator press | HV generator sends | Same |
| | exposure | start signal to Bucky. | |
| | button. | | |
| | | Bucky accelerates grid | Same; Range of possible exposure |
| | | to pre-set velocity | times is limited. |
| 1T2 | Grid reaches | Grid sends ready signal | Same |
| | required | to HV. | |
| | velocity | | |
| T3 | HV receives | Delay time (T3-T2) | Delay time (T3-T2) must be |
| | ready signal | from receipt of ready | known, so that the grid will be at |
| | and begins X- | signal to start of X-ray | the start position with the start of |
| | ray exposure | exposure is not | the X-ray (T3). |
| | | important. | |
| T3- | X-ray | Grid moves in | LG moves in a single direction at a |
| T10 | exposure | reciprocating linear | constant velocity. |
| | | emotion | |
| | | — | AEC sends signal (predetermined |
| | | | completion percentage of |
| | | | exposure) to LG: LG calculates |
| | | | closest “integral multiple of grid |
| | | | cell time” to desired exposure time. |
| T10 | | ARC sends stop signal | LG sends stop signal to HV |
| | | to HV generator at | generator at calculated time to |
| | | 100% completion of | 100% completion of exposure. |
| | | exposure | |
| T11 | End of | HV sends end signal to | Same |
| | exposure | grid. | |

It is according to yet another alternative embodiment of the present invention whereby a useful method for removing scattered radiation by a means of a novel LG is provided (See FIG. 3). The operator sets the AEC mode (301); and presses exposure button (302). High voltage (HV) generator sends a ‘start’ signal to Bucky (303); Bucky accelerates grid to required velocity, and moves grid in reciprocating motion (304). Bucky sends a ‘ready’ signal to HV generator (305); and continues to move grid in linear, reciprocating motion (306). X-ray exposure begins (307); and the AEC sends a ‘stop’ signal to the HV generator (308). The HV generator now ends HV to X-ray tube (309); and the X-ray exposure ends (310). Subsequently, HV generator sends ‘end’ signal to Bucky (311), Bucky stops reciprocating grid motion and moves grid to the aforesaid start position (312).

A novel method is hence disclosed for AEC module X-ray devices wherein the operator sets an AEC mode (351); and presses an exposure button (352). The HV generator sends a ‘start’ signal to LG (353). LG accelerates grid to constant velocity, V₀, and moves grid in a single direction (354); and sends a ‘ready’ signal to HV generator (355). LG continues to move the grid at a constant velocity, V₀, to the start position (356). The HV generator sends HV to an X-ray tube (357) so that X-ray exposure begins (358). AEC sends a ‘stop’ signal to LG (359); and the LG calculates closest said stop time (360). At the calculated stop time, LG sends a ‘stop’ signal to HV generator (361). HV generator ends HV to X-ray tube (362) so that X-ray exposure ends (363). HV generator sends an ‘end’ signal to LG (364) and the LG stops said constant velocity, single direction motion and moves grid to start position (365).

Alternatively and yet according to one embodiment of the present invention, a method for removing scattered radiation by a fixed mAs mode is provided (See FIG. 4), wherein the operator sets technique factors: kV, mA, and exposure time (451); and then presses exposure button (452). The HV generator sends a ‘start’ signal and exposure time to LG (453). LG calculates required velocity; accelerates grid to this velocity (454) and the LG sends a ‘ready’ signal to HV generator (455); LG moves the grid at a constant velocity (456). HV generator sends HV to a X-ray tube (457); so that X-ray exposure begins (458) with the grid at the start position. HV generator ends HV to said X-ray tube (459); so that X-ray exposure ends (460). FV generator sends ‘end’ signal to LG (461); and the LG stops its constant velocity, single direction motion and moves the grid to the aforesaid start position (462).

A rotating grid is presented according to yet another embodiment of the present invention. The means used to rotate the grid are located outside the radiation field. As an example, an electric motor (or motors) may be used to rotate the grid, wherein the motor is located outside the radiation field. The motor may be connected to the grid with a belt drive or gear mechanism or any other appropriate means, which can utilize in contact with the exterior surface of the grid, outside the area of the radiation beam. The rotary motion of the grid is initiated before the X-ray exposure to obtain a constant angular velocity before the start of the X-ray exposure. The angular velocity is constant during the entire X-ray exposure.

Improved grid performance can be achieved by reducing the scatter transmission and by increasing the primary transmission. Scatter transmission can be reduced by reducing the open “acceptance” angle, and/or by reducing the scatter penetration of the septa.

The present invention is thus adapted to successfully utilize a two-dimensional septa structure. As an example, the septa shape can be zigzag, square, hexagonal r any combination thereof. The two dimension septa shape reduce the open angle, versus linear septa geometry, by a factor approximately equal to the grid ratio.

The reduction of scatter penetration of the septa is achieved according to yet another embodiment of the present invention by using septa with dimensions that result in scatter transmission less than 0.5%. For example, for an X-ray spectrum in the range of 40 to 100 kV, a grid lead weight of greater than 1.5 g/cm² transmits less than 0.5% of the scattered radiation.

Primary transmission can be increased by reducing the grid area occupied by the septa and/or by reducing the absorption in the inter-space material. The reduction of the absorption in the inter-space material is achieved according to the present invention by using air instead of aluminum. For example, for X-ray spectrum in the range of 40 to 100 kV, the absorption of air is 2000 times less than aluminum.

In the present invention, the primary transmission of the grid is in the range of 80% (versus 60% for commercially available grids) and the scatter transmission is less than 1% (versus 6% for commercially available grids) and the selectivity is approximately 80 (versus 10 for commercially available grids).

In the present invention, the bucky precisely controls the grid displacement and synchronizes it with the X-ray exposure, wherein the grid is brought to a specific location at the start of the X-ray exposure, and further wherein the grid displacement during the X-ray exposure is precisely controlled

The displacement path length is dependent on the mode of operation, such as fixed mAs mode or AEC mode, the profile of the primary beam intensity and the use of a reference detector.

The result of the grid displacement, for operation without a reference detector, is to create an equal effective primary beam fluence for all detector points, which in turn eliminates the grid-line artifacts from the X-ray image. In the operation with a reference detector, the primary beam intensity and the grid transmissions are measured at each moment of the X-ray exposure, and the measured detector pixel values are normalized with the product of the primary beam intensity with the grid transmission integrated over the exposure time. The normalization procedure eliminates the grid-line artifacts from the X-ray image.

1. An anti-scatter device for X-ray imaging with a position encoder-controlled grid motion comprising:
a. an X-ray radiation source, which produces a primary beam that is directed to an examined body;
b. a high voltage generator in communication with said X-ray radiation source;
c. an X-ray detector;
d. a grid positioned within said primary beam between said examined body and said X-ray detector;
e. an actuating means adapted to move said grid; and
f. a measuring means; adapted to measure the position of the grid during the X-ray exposure; and
g. a controlling means for synchronizing the grid motion with the X-ray exposure.

2. The device according to claim 1, wherein the exposure time is known before the start of the exposure; wherein the X-ray source output is constant; and further wherein the grid velocity is constant and adjusted to said X-ray exposure time such that the grid displacement path length is equal to an integral number of grid cell lengths, and the displacement path is either a rotation about the central axis of the beam or is a linear path that is symmetric with respect to the center position.

3. The device according to claim 1, wherein the exposure time is known before the start of the exposure and the X-ray source output is pseudo-constant; and wherein the grid velocity is constant and adjusted to said exposure time such that the grid displacement is a distance that produces an equal effective primary beam fluence for all the detector points and the displacement path either constant on the central axis of the beam or a linear path that is symmetric about the center position.

4. The device according to claim 1, comprising means for normalizing variations in the primary beam intensity during the exposure time; wherein the X-ray source output and the location of grid are measured continuously during the X-ray exposure and wherein the measured detector values of each detector pixel are normalized by dividing by the effective primary beam fluence of that detector pixel.

5. The device according to claim 1, wherein the grid motion is in a plane perpendicular to the central axis of the X-ray primary beam in such a manner that after a given grid cell time all the grid septa have moved to a location such that the location of the septa pattern in the area between the examined body and the detector is the same.

6. The device according to claim 1, adapted for an AEC operation mode with a pseudo-constant X-ray output source, wherein the exposure time is not known before the start of the exposure; wherein the required exposure time as determined by the AEC is adjusted by the control means so that the the grid displacement is a distance that produces an equal effective primary beam fluence for all the detector points and the displacement path is either constant on the central axis of the beam or a linear path that is symmetric about the center position;
characterized by control means adapted to receive a signal from the AEC when a known percentage of the required exposure time has been obtained; said control means are adapted to calculate the closest integral multiple of the grid cell time to the required exposure time and to send a termination signal to the high voltage generator at that calculated time.

7. The device according to claim 1, adapted for an AEC operation mode with a constant X-ray output source, wherein the exposure time is not known before the start of the exposure; wherein the required exposure time as determined by the AEC is adjusted by the control means so that the grid displacement during the X-ray exposure is equal to a integral number of grid cell lengths;
characteized by control means adapted to receive a signal from the AEC when a known percentage of the required exposure time has been obtained; said control means are adapted to calculate the closest integral multiple of the grid cell time to the required exposure time and to send a termination signal to the high voltage generator at that calculated time.

8. The device according to claim 1, wherein the grid is characterized by a repeating pattern of radiopaque septa and radiolucent inter-space material

9. The device according to claim 1, wherein the grid motion is linear, oscillatory, rotary, circular or any combination thereof.

10. The device according to claim 1, comprising a rotary actuating means in which the rotation axis is coincident with the central axis of the X-ray beam and the displacement path is constant on the central axis of the beam.

11. The device according to claim 1, wherein the actuating means of the grid has a position encoder.

12. The device according to claim 1, wherein the position of the grid, at a reference point, with respect to the X-ray detector is known, so that at grid positions offset from the reference position, the position of the grid with respect to the X-ray detector is known.

13. The device according to claim 1, wherein the encoder comprises inter alia a time clock, which measures the position of the grid as a function of time so that the calculation of the exact position of the grid with respect to the X-ray detector pixels is known and the grid transmission in known for each moment of the X-ray exposure for each detector point at each moment during the X-ray exposure.

14. The device according to claim 1, adapted to utilize a two-dimensional septa structure in such a manner that in a given grid ratio, the open angle of the two-dimensional grid is reduced, versus a linear grid, by a factor approximately equal to the grid ratio.

15. An anti-scatter device for X-ray imaging with a position encoder-controlled grid motion comprising:
a. an X-ray radiation source, which produces a primary beam that is directed to an examined body;
b. a high voltage generator in communication with said X-ray radiation source;
c. an X-ray detector;
d. a grid positioned within said primary beam between said examined body and said X-ray detector; adapted to absorb X-rays that were scattered by said examined body;
e. an actuating means adapted to move said grid; and
f. a measuring means; comprising inter alia a time clock adapted to measure the position of the grid as a function of time during the X-ray exposure;
g. at least one reference detector comprising inter alia a time clock, adapted to measure said X-ray source output as a function of time; and,
h. a controlling means for synchronizing the grid motion with the X-ray exposure;
wherein pixel values are normalized by the effective primary beam fluence which is the product of the X-ray source output, as measured by said reference detector;
and wherein the grid transmission function as known from the measured position of the grid is integrated over the exposure time, so that the need for a constant or pseudo-X-ray source output is eliminated.

16. The device according to claim 15, comprising a rotary actuating means wherein the radiopaque septa are focused for all rotational displacements.

17. The device according to claim 15, wherein the encoder comprises inter alia a time clock which measures the position of the grid as a function of time, so that calculation of the exact time that each pixel is covered by septa is provided.

18. A method for removing scattered radiation comprising the steps of:
a. accelerating the grid to a predetermined velocity and then moving the grid at said predetermined velocity to a predetermined start position that is one half the distance of the predetermined displacement length from the center position;
b. emitting a primary X-ray beam;
c. absorbing said primary X-ray beam in an X-ray detector while the grid is moving in such a manner that the grid absorbs an equal measure of said primary beam for each detector point;
d. terminating the X-ray exposure; and then,
e. terminating the grid motion.

19. The method according to claim 18 applied in a device including at least one reference detector, comprising the steps of measuring the primary beam intensity during the exposure time, while measuring the grid location during the exposure time; absorbing the transmitted beam in the X-ray detector; and normalizing the measured detector values with the effective primary beam fluence so that any continuous non-constant X-ray source can be used.

20. The method according to claim 18 useful for endless rotating grid motion, additionally comprising the step of measuring the radial displacement of said grid.

21. The method according to claim 18, adapted for a prolonged exposure time.

22. The method according to claim 18, adapted for an AEC mode comprising the steps of:
a. setting an AEC mode;
b. accelerating the grid to a constant and predetermined velocity and to a predetermined start position;
c. sending a ‘ready’ signal from the grid;
d. initiating the emission of the primary X-ray beam by a high voltage generator;
e. sending a ‘stop’ signal by the AEC to the LG; said LG comprises of a processor adapted to calculating the closest stop time for which an equal effective primary beam fluence for each detector point is obtained;
f. sending a ‘stop’ signal, at the calculated time to the HV generator, and hence end HV supply to said X-ray tube so that the exposure ends at the calculated time;
g. sending an end signal from HV generator to the LG, so said grid motion ends
h. returning the grid to a start position.

23. The method according to claim 18, adapted for an mAs mode anti-scatter device for X-ray imaging with an encoder-controlled position grid motion; comprising the steps of:
a. setting an mAs mode and setting parameters selected from kV and mA and exposure time;
b. sending a ‘start’ signal and exposure time to LG;
c. calculating the required grid velocity for the given exposure time;
d. accelerating grid to said constant velocity to a predetermined start position;
e. sending a ‘ready’ signal to the HV generator when the grid is at the start position;
f. sending high voltage to a X-ray tube so that X-ray exposure begins;
g. ending high voltage to said X-ray tube so that X-ray exposure ends;
h. sending ‘end’ signal to LG so that LG stops its constant velocity, single direction grid motion; and then,
i. moving the grid to the start position.
